(19) United States
(12) Patent Application Publication
(10) Pub. No.: US 2012/0296715 A1
(43) Pub. Date: Nov. 22, 2012

(54) MANAGEMENT OF AN OFFER FOR A FINANCIAL INCENTIVE

(76) Inventors: Pierre C. Barbeau, Leawood, KS (US); James D. Barnes, Overland Park, KS (US); Jeremy D. Lyman, Overland, KS (US)

(21) Appl. No.: 13/111,185

(22) Filed: May 19, 2011

(51) Int. Cl. G06Q 30/00

(52) U.S. Cl. 705/14.13; 705/14.1; 705/14.26

(57) ABSTRACT

Management of an offer for a financial incentive offered by an offeror and, in particular, management of redemption of the offer by a particular user which eliminates the need for a redemption entity to capture a user-unique redemption code or otherwise report redemption in order to track and control the user's redemption of the offer is disclosed. Instead, the user's revelation of the redemption code, via a device associated with the user, may be considered a redemption of the financial incentive by the user regardless of whether the user actually receives the incentive. In particular, offers for financial incentives may be provided in an electronic form to a user, via a device associated with the user, such as the user's personal computer or mobile device, from an offer server, such as via a wired and/or wireless network. The offer includes a redemption code which must be exchanged/presented to the redemption entity, e.g. a merchant or retailer, to obtain the financial incentive. Upon delivery of the offer to the user's device, the redemption code is concealed from the user by the device such that user must take some subsequent action to reveal it, ideally in the presence of the redemption entity or otherwise substantially contemporaneously with the purchase. The revelation, or the attempt thereto, of the redemption indicia may cause the offer to be considered redeemed by the offer server and prevent a subsequent redemption. Upon presentment of the redemption code, the redemption entity provides the requisite financial incentive.

### BACKGROUND

Coupons, rebates, discounts, deals and other financial incentives, referred to generally as coupons, are often used by merchants, manufacturers or other offerors, as marketing tools to entice or otherwise incentivize consumers to purchase or try products or services, such as by rewarding existing customers and/or attracting new customers. Typically, these financial incentives are effected via a paper certificate/document/ticket or card which provides details about the offer and which the consumer exchanges, or otherwise presents, to a merchant, retailer or other redemption entity, in order to obtain the financial incentive, such as at the time of purchase, or in the case of a rebate, subsequent to the purchase. These coupons may be consumer- or consumer-group specific, e.g. customized to a specific consumer group or specific consumer such as by identifying the consumer, including a consumer-customized offer or including a consumer-specific code, or may be generic and widely published, such as via a newspaper. Regardless, coupons may provide a merchant, manufacturer or other entity with the ability to offer the financial incentive to a subset of consumers, e.g. those most likely to be interested in the associated product or service, control redemption, e.g. so as to minimize losses, and benefit from the marketing effect, e.g. increase sales to existing customers and/or obtain new customers.

In the online/e-commerce context, financial incentives may be distributed, physically or electronically, as codes which the consumer enters, for example, by typing the code into a designated form field when purchasing a product, via a web page for example, to obtain the financial incentive. In the mobile context, financial incentives, e.g. the codes therefore, may be distributed via a mobile device, such as via e-mail, SMS text message, mobile web browser or a proprietary application, e.g. “app”, executing on the device.

Regardless of the type of financial incentive or the medium of distribution, to maximize benefits to the offeror and minimize losses due to fraud, the distribution of the offer of a financial incentive should be controlled and redemption thereof should be managed and tracked while minimizing the burden on the offeror and/or redemption entity.

### BRIEF DESCRIPTION OF THE DRAWINGS

FIG. 1 depicts a block diagram of a system for managing an offer for a financial incentive.

FIG. 2 depicts a flow chart showing operation of the system of FIG. 1.

FIG. 3 depicts an exemplary computer system for use with the system of FIG. 1.

### DETAILED DESCRIPTION OF THE DRAWINGS AND PRESENTLY

### Preferred Embodiments

The disclosed embodiments relate to management of an offer for a financial incentive offered by a merchant, manufacturer, retailer or other offeror and, in particular, to a system and method for managing redemption of the offer by a particular user/consumer which eliminates the need for a redemption entity to capture a user-unique redemption code or otherwise report redemption in order to track and control the user's redemption of the offer. Instead, as will be described in detail below, the user's revelation of the redemption code, via a device associated with the user, may be considered a redemption of the financial incentive by the user regardless of whether the user actually receives the incentive. In particular, offers for financial incentives may be provided in an electronic form to a user, via a device associated with the user, such as the user's personal computer or mobile device, from an offer server, such as via a wired and/or wireless network. The offer includes a redemption code which must be exchanged or otherwise presented to the redemption entity, e.g. a merchant or retailer, to obtain the financial incentive. Upon delivery of the offer to the user's device, the redemption code is concealed from the user by the device such that user must take some subsequent action to reveal the redemption code, ideally in the presence of the redemption entity, i.e., the merchant/retailer, or otherwise substantially contemporaneously with the purchase, e.g. for web based transactions. In one embodiment, the user's attempt to reveal the redemption code causes the device to validate the offer with the offer server which determines whether or not the offer is valid, e.g. is redeemable, and, if valid, causes the offer server to log the offer as having been redeemed by the user. If the offer server responds to the device that the offer is valid, the device may reveal the redemption code so that the user can present it to the merchant/retailer, otherwise the device may be prevented from revealing the redemption code. If the server responds to the device that the offer is invalid or otherwise not redeemable, e.g. expired or previously redeemed, a suitable message may be displayed or provided informing the user thereof. In an alternative embodiment, the user's attempt to reveal the redemption code causes the device to validate the offer with the offer server wherein the offer server, if the offer is valid, responds as such but does not yet mark the offer as redeemed. Instead, the validation of the offer may cause the user's device to display a warning that the user's continued attempts to reveal the redemption code will reveal the code and cause the offer server to log the offer as having been redeemed, thereby affording the user an opportunity to abort the revelation/redemption process prior to revelation of the redemption code and avoid redemption thereof. Should the user continue to attempt to reveal the redemption code, the redemption code may be revealed contemporaneously, or at a later time, with a transmission by the device 104 to the offer server 102 of a message indicative thereof, the offer server 102, upon receipt of the message, updating the offer to indicate that it has been redeemed. In yet another alternate embodiment, the user's revelation of the redemption code may be subsequently reported to the offer server at a later time. In the case of a one-time offer, when the user navigates away from the revealed redemption code or otherwise clears the display, they are unable to subsequently re-reveal that redemption code, e.g. the offer/redemption code may be deleted or otherwise rendered inaccessible to the user. For example, the offer or redemption code may be partially displayed or obscured by a indication that the offer has been redeemed or has expired. As noted above, this may occur regardless of whether the user presents the offer to the redemption entity or actually receives the financial incentive. Upon presentment of the redemption code, the redemption entity, i.e. the merchant, provides the requisite financial incentive.

As used herein, the term “coupon” refers to any offer of a financial incentive related to the purchase of, or subscription to, a product or service, such as a discount, rebate, additional or complementary product or service, or combination thereof, which requires, contemporaneously with the purchase, the exchange or presentation, visually, audibly or via an input device, such as an optical scanner, RFID or other near field communication reader, or virtual or physical keyboard, of an indicia, such as a redemption code, identifying the offer, whether the indicia is unique to the bearer or not, whether the indicia is affixed to a paper, card or other physical medium or displayed via a display or otherwise emitted, broadcast, transmitted or annunciated by an electronic device. As used herein, a “electronic coupon” refers to a coupon wherein the indicia identifying the offer or required to be presented is displayed via, or emitted or annunciated by, an electronic device, such as a computer, e.g. desktop or laptop computer; network appliance, e.g. Internet enabled kitchen appliance, set top box or gaming console; or mobile device, e.g. cellular telephone, smart phone, tablet computing device, personal digital assistant, etc. In the context of mobile devices, electronic coupons may also be referred to as “mobile coupons.” A coupon may be offered by an offeror, such as a merchant, retailer, manufacturer or other entity, for redemption by a redemption entity, such as a brick and mortar or e-commerce merchant, retailer or other entity which may be the same as, different from, related to or unrelated to the offeror.

While electronic coupons, such as mobile coupons, have been implemented in a variety of ways, such as via SMS text messages, trackable redemption of these coupons has required that the merchant implement mechanisms to capture and validate the offer and/or the consumer unique redemption code associated therewith and presented by the consumer at the time of purchase, such as via their point of sale (“POS”) system, to ensure that the consumer is entitled to the financial incentive. Not only does this require that the merchant modify their POS system, such as to include a function to capture the redemption code and provide a network interface to connect with a back end system for validation and logging/recording of redemption, but this also introduces delay in the check-out process which, depending on the type of product, the merchant may not find tolerable, e.g. the check-out lines or waiting times may be too long causing some customers to abandon their purchases.

The disclosed embodiments encourage the user to redeem an offer for a financial incentive substantially contemporaneously with the controlled revelation of a concealed redemption code and, thereby, substantially contemporaneously, e.g. prior to or along with payment, with the corresponding purchase, ensuring that the redemption entity, i.e. the merchant/retailer, provides the appropriate financial incentive only to the user bearing the revealed redemption code and allowing for the tracking and control of the redemption independent of the merchant's point of sale system. This obviates the need for the merchant to implement a mechanism for validating redemption codes with the offer server prior to providing the financial incentive and eliminates the need to use user-unique redemption codes to control and track the user's redemption of the offer. In the case of merchants which already offer financial incentives via redemption codes, such as via paper or mobile coupons, which their POS systems are already configured to receive so as to automatically apply the financial incentive, the same codes may be used by the disclosed embodiments further minimizing the burden on the merchant while improving the ability to manage redemption as described herein. It will be appreciated that, for merchants which permit redemption of offers, such as general discounts or credits, in advance of a specific purchase whereby the redeemed offer is credited to a user's account, such as in the form of a monetary credit, and available to be used for a purchase at a later time, the transaction by which the offer is credited to the account may be considered the redemption event for purposes of this disclosure. For example, Amazon.com permits the redemption of monetary credits where the redeemed credit is held on account for the user to be used for a subsequent purchase which may not be contemporaneous with the redemption.

To clarify the use in the pending claims and to hereby provide notice to the public, the phrases “at least one of <A>, <B>, . . . and <N>” or “at least one of <A>, <B>, . . . <N>, or combinations thereof” are defined by the Applicant in the broadest sense, superceding any other implied definitions herebefore or hereinafter unless expressly asserted by the Applicant to the contrary, to mean one or more elements selected from the group comprising A, B, . . . and N, that is to say, any combination of one or more of the elements A, B, . . . or N including any one element alone or in combination with one or more of the other elements which may also include, in combination, additional elements not listed.

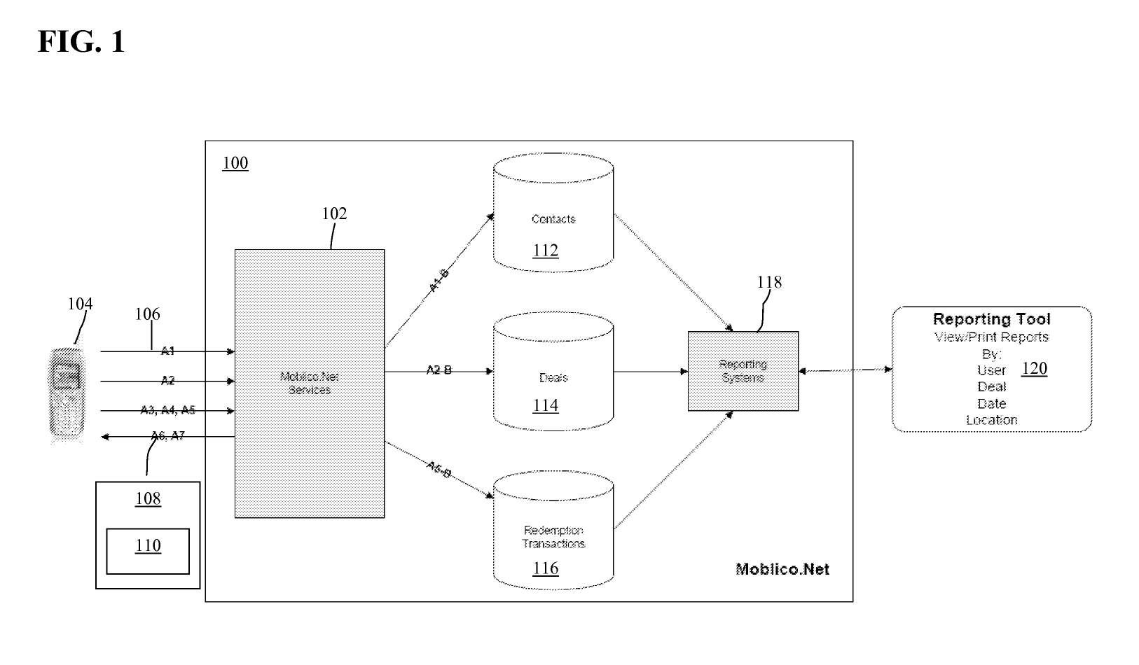

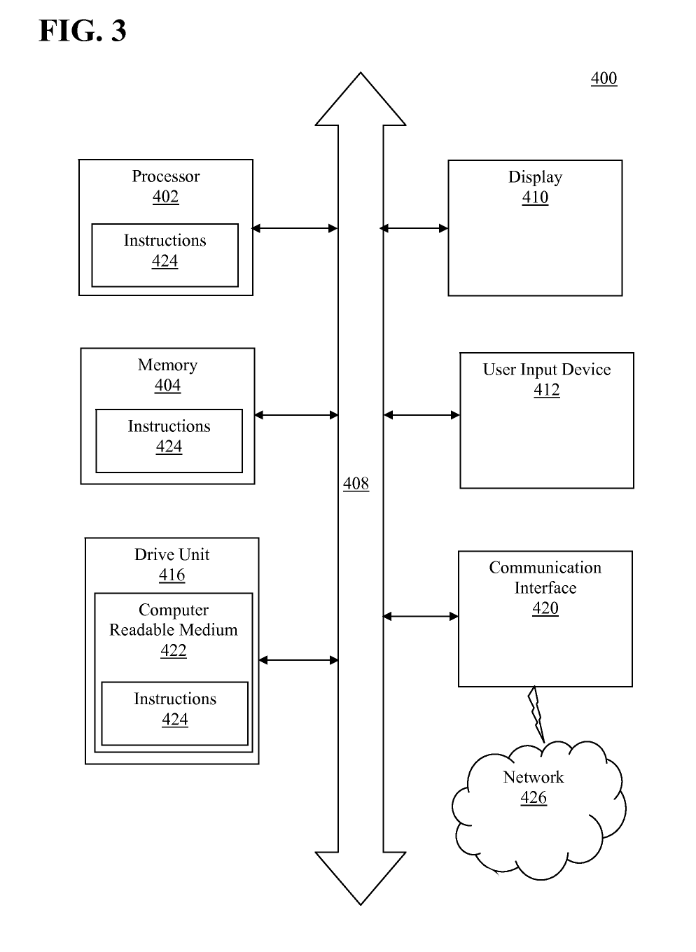

Referring to FIG. 1, there is shown a block diagram of one embodiment of a system 100 for managing an offer for a financial incentive, such as a mobile coupon for a price discount for a product or service offered by an offeror, such as a merchant, retailer, manufacturer or combination thereof. The system 100 includes an offer server 102 which is coupled with a device 104, such as a computer, e.g. desktop or laptop computer; network appliance, e.g. Internet enabled kitchen appliance, set top box or gaming console; or mobile device, e.g. cellular telephone, smart phone, tablet computing device, personal digital assistant, electronic book reader, etc., or other proprietary or non-proprietary wired or wireless communications device, via a wired and/or wireless network 106. Herein, the phrase “coupled with” is defined to mean directly connected to or indirectly connected through one or more intermediate components. Such intermediate components may include both hardware and software based components. In one embodiment, the offer server 102 may be implemented as computer program logic or computer readable program code stored in the memory and/or storage of a computer, such as the computer 400 described below with respect to FIG. 3, and executable by one or more processors thereof to implement the disclosed functionality. The system 100 may further include a contacts database 112, a deals database 114, a redemption transaction database 116, a reporting system 118 and a reporting tool 120. While the contacts, deals and redemption transaction databases 112, 114, 116 are depicted separately, it will be appreciated that they may be implemented as a single database having one or more tables, on single or multiple storage devices or memories. The contacts database 112 may store and/or maintain contact information, such as network identifiers, e.g. IP addresses, telephone numbers, electronic serial numbers, email addresses, etc., for registered users and/or their devices 104. The deals database 114 may store and/or maintain data representative of the various financial incentives available to be provided by the system 100 and may also store data representative of previously available financial incentives. The redemption transactions database 116 may store data representative of the redemption of offers by the users as described herein. The reporting system 118 may be accessed by offerors or other entities, such as via the reporting tool 120, which may comprise a user interface, to report on, add, remove or modify registered users in the contacts database, report on, review, add, modify or remove deals in the deals database 114, and/or report on or review redemption data stored in the redemption transactions database 116, as described in more detail below.

The device 104 may be associated with a user interested in receiving offers for financial incentives, such as a user who registers themselves and/or their device 104 with the offer server 102 or is otherwise represented in the contacts database 112. The network 106 may be a wireless network or a combination of a wired and wireless network, such as a cellular telephone network and/or 802.11x compliant network, and may include a publicly accessible network such as the Internet, a private network, or combination thereof. It will be appreciated that the type and configuration of the communications network 106 is implementation dependent and any type of communications network which facilitates the described communications between the offer server 102 and the device 104, available now or later developed, may be used. The offer server 102 may communicate with the device 104 using native or modified communications functionality of the device 104, such as using the short message service (“SMS”) or multimedia message service (“MMS”) text message protocol, the hyper text transport protocol (“HTTP”) via a web browser application provided by the device 104, the simple mail transfer protocol (“SMTP”), or other email communications protocol, via an email application, provided by the device 104, via a proprietary application (“app”) specifically installed on the device 104, which may use a proprietary or non-proprietary protocol, to implement the disclosed functionality, via the telephony functions of the device 104, such as via touch-tone or interactive voice response mechanisms, or a combination thereof.

The offer server 102 is operative to transmit, based on the data stored in the contacts database 112, such as via SMS, HTTP, or other proprietary protocol, non-proprietary protocol, or combination thereof, to the device 104, data 108 representative of one or more offers for financial incentives, which may be stored in the deals database 110. The offer server 102 may transmit the data 108 in response to a request received from the device 104, e.g. “pull,” and/or transmit the data 108 automatically, such as on a periodic schedule or in response to an event or other signal, e.g. “push.” The data 108 comprises at least a redemption indicia 110 operative to be presented, e.g. visually, audibly, via entry using a user input mechanism and/or via radio frequency transmission, such as RFID, near-field communications (“NFC”), Wi-Fi or Bluetooth, to a merchant or other redemption entity to obtain the financial incentive. The data 108 may further include a description of the offer, in the form of text and/or one or more graphic images or animations, and any conditions and/or instructions thereon to be displayed on, or evaluated or implemented by, the device 104, such as start/availability date, expiration date, number of allowed redemptions, etc. The data 108 may also include data specifying and/or describing conditions or restrictions, stored in the deals database 114, which control the user's ability to cause the device 104 to reveal the redemption indicia 110 as will be described in more detail below. The device 104 is further caused, as will be described below, to conceal the redemption indicia 110, e.g. inhibit the presentation thereof, until the user causes the device 104, possibly subject to conditions as will be described, to reveal the redemption indicia 110 for presentation. It will be appreciated that, for some offers, some or all of the parameters of the offer may also be concealed along with the redemption indicia. For example, the extent or amount of an offered discount may be concealed from the user until revelation. The offer server 102 is further operative to determine whether the user has caused the device 104 to reveal the redemption indicia 110 for presentation and, based thereon, account for the redemption of the offer by the user, such as by storing data indicative thereof in the redemption transactions database 116. For example, as will be described, the device 104 may send a signal or message to the offer server 102 when the user attempts to, or is successful in, revealing the redemption indicia. This signal or message may identify the user and/or the device 104 and may include additional information relating to the revelation of the indicia, such as the date or time, GPS coordinates or other location data provided by the device 104 indicative of the location thereof, confirmation information entered by the user or merchant as described below, or other information. In one embodiment, the offer server 102 invalidates the offer for subsequent revelation or redemption based on the determination that the user has caused the device to reveal the redemption indicia regardless whether or not the user has actually received the financial incentive. In an alternate embodiment permitting a limited or unlimited number of redemptions, the offer server is further operative to adjust a count of the number of redemptions of the offer, which may be stored in the redemption transactions database 116, based on the determination that the user has caused the device 104 to reveal the redemption indicia. In the case of a limited number of redemptions, the offer server 102 may further compare the number of redemptions against a threshold and invalidate the offer for the current or subsequent revelation or redemption if the number of redemptions equals or exceeds the threshold, or, in the case of a redemption count which is decremented with each redemption, if the number of remaining redemptions is zero.

In one embodiment, the offer server 102 must enable the device 104 to reveal the redemption indicia. In particular, the offer server 102 may be further operative to, prior to the determination that the user has caused the device 104 to reveal the redemption indicia, determine that the user is attempting to cause the device 104 to reveal the redemption indicia, such as by receiving a signal from the device 104 generated in response to the user attempting to reveal the redemption indicia, the signal identifying the offer, the device 104, the user or a combination thereof. The offer server 102 may then determine whether the offer associated with the redemption indicia is valid and enable the device 104 to reveal the redemption indicia if the offer associated with the redemption indicia is valid and otherwise prevent the device 104 from revealing the redemption indicia, such as by transmitting a signal indicative thereof back to the device 104 which is responsive thereto. In one embodiment, if the offer is valid, the offer server 102 may cause the device 104 to warn the user that their continued attempts to reveal the redemption indicia will result in redemption of the offer, thereby affording the user an opportunity to abort their attempt and avoid redemption, e.g. if the attempted revelation of the redemption indicia was made in error. Such mechanisms to prevent unintended revelation may be important in embodiments where offers are considered to have been redeemed regardless of whether the redemption code was actually presented or the financial incentive actually received. In one embodiment, the redemption code must be revealed for a minimum amount of time to be considered revealed and if the user re-conceals the redemption code, e.g. by navigating away from the display thereof, prior to the elapse of the specified minimum amount of time, the redemption of the offer will not be considered to have occurred. In one implementation, a timer may be displayed showing the elapse of time or other indication of the opportunity to preserve the offer for later redemption.

In one embodiment, attempted revelation of the redemption indicia may be treated as having successfully done so. For example, the offer server 102 may be further operative to determine that the user has caused the device 104 to reveal the redemption indicia based on receipt of a message from the device 104 indicating that the user has at least attempted to cause the device 104 to reveal the redemption indicia, the message having been automatically transmitted in response thereto.

In one embodiment, once the data representative of the offer is transmitted by the offer server 102 to the device 104, the user may be able to cause the device 104 to reveal the redemption indicia without further interaction with the offer server 102. This enables the user to reveal the redemption indicia in situations where the ability of the device 104 to communicate is compromised, e.g. in areas of intermittent or no network connectivity, no cellular or Wi-Fi signal, etc. In one embodiment, this ability to reveal the redemption indicia may be allowed only after the device 104 first attempts but then fails to validate the offer with the offer server 102. The device 104 may then transmit a message, indicating that the user has revealed the redemption indicia, to the offer server 102 once the device 104 is again able to communicate or at a later time. Alternatively, when the device 104 cannot validate the offer with the offer server 102, the user is prevented from revealing the redemption indicia and, for example, may be presented with a message indicating that the offer is currently unredeemable and that they should try again at a later time.

In the case of a one-time offer or, in the case of a limited offer, where the allocated redemptions have been exhausted, the offer may be deleted from the device 104 or otherwise rendered inaccessible or unviewable once the user navigates away from the display of the revealed indicia or otherwise performs some other action with their device 104 which changes the display. In one embodiment, the offer and/or redemption indicia 110 may remain at least partially viewable/obscured by an indication that the offer has been redeemed or is expired. In the case of a time limited offer where the time limit has expired, the offer may be deleted from the device or otherwise rendered inaccessible or unviewable regardless of whether the user has revealed the indicia 110. For limited time offers or offers featuring multiple redemptions, an indication of the remaining time or number redemptions may be provided. The rendering of an offer as inaccessible or unviewable, etc. or the presentation of indications thereof or of remaining time or remaining redemptions, may be performed by the device 104, such as by an “app” executing on the device 104, based on the conditions transmitted with the offer, e.g. by comparing the expiration date with the current date, by the offer server 102 via transmission of data operative to cause the device 104 to render the offer inaccessible or unviewable or present the requisite content, or a combination thereof.

The redemption indicia 110 may include an alphanumeric code, a machine readable code, such as bar code or QR code, an image, an audible message, a signal operative to be transmitted via a radio frequency or other medium, or combination thereof. In one embodiment, the redemption indicia 110 is unique to the user and/or device 104. In one embodiment, once revealed, as will be described below, the user presents the redemption indicia 110 to the merchant, retailer or other redemption entity, by displaying the redemption indicia 110 on the display of their device 104, or otherwise causing the device 104 to emit or annunciate the redemption indicia, so that the merchant, or representative thereof, is able to perceive it, e.g., view, read, scan, receive and/or hear it. In an alternative embodiment, the user presents the redemption indicia 110 to the merchant by viewing it on the of the display of their device 104 and manually entering, e.g. typing or clicking a mouse button, the redemption indicia 110, e.g. redemption code, via a user input device (not shown), such as a pin-pad, key pad or keyboard provided at a point of sale, or a data input field/object provided on a merchant web page.

In one embodiment, the user causes the device 104 to reveal the redemption indicia by performing a specific interaction with the device 104 such as selecting the offer from a list presented via a user interface of the device 104. To prevent the user from accidentally revealing the redemption indicia 110, a second confirmatory action by the user may be required, prior to or after validation with the offer server 102, such as selecting a “yes” option on the user interface of the device 104 in response to an “are you sure?” query. In one embodiment, multiple actions may be required to reveal the redemption indicia wherein the first action is considered an attempt to reveal the redemption indicia triggering the validation protocol described above and wherein a subsequent action may only be performed to ultimately reveal the redemption indicia once the offer has been validated by the offer server 102. In one embodiment, the user interface of the device 104 featuring a touch screen display or other interactive display is caused, such as by an offer application executing thereon, to present a simulated scratch off display, the illusion of which gives the appearance that the redemption code is displayed “underneath” the simulated scratch off covering. The user then interacts with a display using rubbing or scratching motions to progressively reveal the redemption indicia, the first of which may trigger the validation protocol wherein, if the offer is invalid, a message indicative thereof is displayed “underneath” the scratch off cover instead of the redemption indicia. The application may be programmed to ensure that a specific number of “scratches” are required to fully display the redemption indicia in a redeemable form, e.g. each scratch interaction causes a configurable and/or variable percentage of the indicia to be revealed. It will be appreciated that other user interactions, simulated or otherwise, may be implemented which facilitate and confirm the user's intention to reveal the redemption indicia and minimize accidental revelation thereof. In one embodiment for use on devices 104 which may or may not feature a touch sensitive display screen, the user may repeatedly press a key or button, move a mouse or other user input device, or otherwise undertake a series of interactions with the device 104 via an available user input mechanism of the device 104 to initiate and complete, e.g. progressively, the reveal operation. For example, for devices 104 featuring motion sensors, such as accelerometer or gyroscope sensors, the user may shake or otherwise move the device 104. In one embodiment for devices featuring GPS capability, the user may simply need to physically bring the device 104 to, or remove the device 104, from a specific geographic location or region upon which the redemption indicia is automatically revealed. This may be set as a condition of the offer by an offeror which only wants the offer to be valid for one visit to the location, such as a particular retail venue, whether or not the user redeems the offer.

Other mechanisms may also be provided to control revelation of the indicia 110, e.g. minimize accidental revelation of the redemption indicia or otherwise minimize the occurrence of fraudulent or otherwise improper redemption or obtaining of the financial incentive by the bearer or a consumer other than the bearer. In one embodiment, the data representative of the offer for the financial incentive may further include one or more conditions to be satisfied to enable the user to cause the device to reveal the redemption indicia. For example, the offer may be time limited whereby upon lapse of the offer, it may no longer be revealed. Alternatively, or in addition thereto, the user may need to enter a code into an application executing on the device 104 wherein the code is only provided by the redemption entity at the time of the purchase or is otherwise only available within a physical location, such as displayed on a sign within a retail establishment, In one embodiment, the user may be required to provide their device 104 to the merchant, or representative thereof, who enters the code themselves or performs some other confirmatory action. In an alternative embodiment, the condition may comprise a substantial match or convergence between specified geographic coordinates or coordinate ranges/geographic boundaries and coordinates provided by a GPS or other location determining device contained within the device 104. For example, the condition may include the geographic coordinates of one or more retail locations of the merchant such that the user may only reveal the redemption indicia when their device 104, and presumably the user themselves, are physically located within or substantially proximate to one of the specified retail locations. Given the inherent imprecision of GPS and other location determining devices, only a substantial match may be required, such as within 100 feet or less of the specified coordinates or being within a defined geographic boundary. GPS/geographic based conditions may, alternatively, be used to prevent redemption in particular locations or regions. It will be appreciated that there may be other conditions that may be implemented, alone or in combination, to ensure the presence of the user/device 104 at a given location or region such as the detection of a specific available Wi-Fi network within range of the device 104. In one embodiment, the device 104 may be enabled, such as via an “app” program executing on the device 104, to evaluate the satisfaction of the conditions and determine if they are satisfied in order to enable the redemption indicia to be revealed. In an alternate embodiment, the device 104 collects and transmits data to the offer server 102 which determines if the conditions have been satisfied and returns a message back to the device 104 to enable or prevent revelation of the indicia depending on the result. In yet another alternative embodiment, the device 104 and offer server 102 may collaborate on the evaluation of the conditions to determine the satisfaction thereof. It will be appreciated that offer conditions, including GPS based conditions, may apply to the offer generally or may vary depending on the user and that such conditions may be used to segregate offers among users or otherwise segment markets to control redemption, such as to limit redemption to particular geographic areas and/or markets. For example, a travel related offer may be limited to redemption anywhere except the user's home city.

In one embodiment, the user may first register with the offer server 102, such as via a web page, device-based application (“app”), telephone call, SMS or MMS text message, electronic mail submission or other interaction with the offer server 102, that they are interested in receiving offers for financial incentives. The registration may be stored in the contacts database 112. The offer server 102 is operative to register the device 104 associated with the user, such as by registering the email address, telephone number, device identifier and/or IP address associated therewith, and store, in the contacts database 112, an association between the user and any offers for financial incentives subsequently transmitted to the user's device 104 as described. As part of the registration, the offer server 102 may further receive user data representative of at least one of the user's interests, preferences, demographics, biographical information, or combinations thereof, e.g. a user profile, such as via an interactive survey or questionnaire, whereby the offer server 102 may determine or otherwise select particular offers, such as from among those stored in the deals database 114, to be transmitted to the user's device 104 from a plurality of offers available to be provided to the user based on the received user data. In one embodiment, the offer server 102 may generate offers unique, or substantially unique, to the user, or a group of users, based on the received user data.

Other mechanisms may be provided for preventing fraudulent or otherwise improper redemption/obtaining of the financial incentive by a consumer bearing the redemption indicia or a consumer other than the bearer. In one embodiment, the offer server 102 may be further operative to receive data indicative of the redemption of the offer from the merchant, such as via the reporting tool 120 and reporting system 118, such as on a periodic schedule, and reconcile the received data with the accounted for redemption by the user, which may be stored in the redemption transactions database 116. The offer server may be further operative to detect fraudulent redemption based on the reconciliation such as by detecting that the offer has been redeemed more than the number of offers transmitted or, in the case where unique redemption indicia are utilized, that an identical redemption indicia has been presented by more than one user. In the case where the offeror is not the redemption entity, the reconciliation may be used to detect fraudulent redemption by the redemption entity, such as where the redemption entity seeks reimbursement for having provided the financial incentive when, in fact, they have not done so. The offer server may also be further operative to determine marketing effectiveness of the offer based on the reconciliation, such as by tracking the frequency of redemption as a function of the number of offers and the demographics of the offerees.

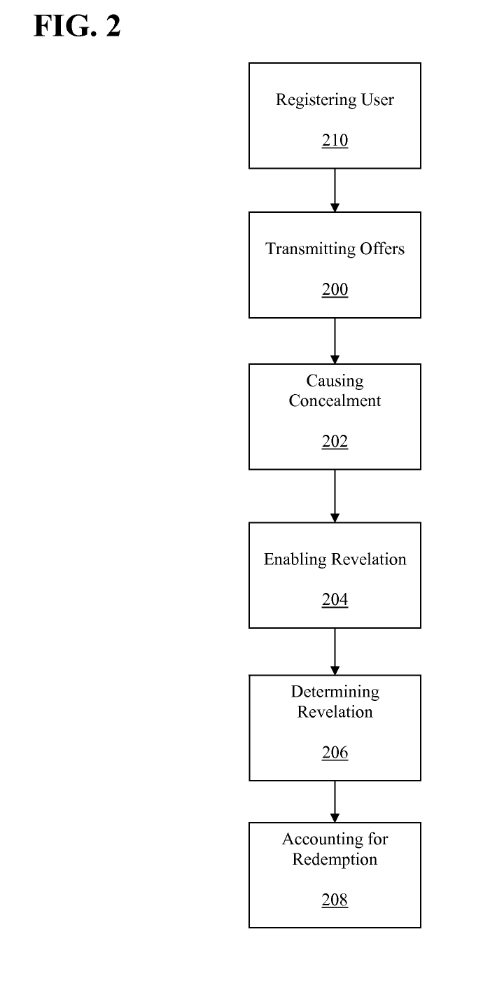

Referring to FIG. 2, there is shown a flow chart depicting the operation of the system 100 for managing an offer for a financial incentive according to one embodiment. In one embodiment, the system 100 includes an offer server 102, implemented as a computer having a processor and a memory coupled therewith. The operation includes transmitting, such as via the execution by the processor of first logic stored in the memory, to a device 104 associated with a user, such as a mobile device 104, interested in receiving offers for financial incentives, by the computer, data 108 representative of the offer for the financial incentive (block 200), wherein the data comprises at least a redemption indicia 110 operative to be presented to a merchant to obtain the financial incentive, and causing the device 104 to conceal the redemption indicia 110 until the user causes the device 104 to reveal the redemption indicia 110 (block 202). The financial incentive may include a price discount for a product or service offered by the merchant. The redemption indicia 110 may be unique to the user and may include an alphanumeric code, a machine readable code, an image, an audible message, a signal operative to be transmitted via a radio frequency, or combination thereof. The transmitting may be in response to a request received from the device 104. The transmitting of the data may be performed via an application executing on the device 104, such as a proprietary application program or a web browser program. The data representative of the offer for the financial incentive may further include a description of the offer operative to be displayed by the device 104 and/or include a condition to be satisfied to enable the user to cause the device 104 to reveal the redemption indicia 110. The condition may include a substantial convergence between specified geographic coordinates and coordinates provided by a GPS device contained within the device. Alternatively, or in addition thereto, the condition may include performance of a confirmatory action by the merchant. In one embodiment, the operation of the system 100 may further include enabling the device 104 to reveal the redemption indicia 110 in response to a specific user interaction with the device 104, such as a simulated scratching motion on an interactive display of the device 104 (block 204).

The operation of the system 100 further includes, determining, by the computer, that the user has caused the device to reveal the redemption indicia 110 (block 206) and accounting, by the computer, for the redemption of the offer by the user based thereon (block 208), such as by invalidating the offer for subsequent redemption and/or adjusting a count of the number of redemptions of the offer.

The operation of the system 100 may further include registering, by the computer, the device associated with the user, the computer storing an association between the user and the offer for the financial incentive represented by the transmitted data (block 210). The registering may further include receiving user data representative of at least one of the user's interests, preferences, demographics, biographical information, or combinations thereof, and/or prior to the transmitting, determining the offer from a plurality of offers available to be provided to the user based on the received user data.

The operation of the system 100 may further include, prior to the determining that the user has caused the device to reveal the redemption indicia, determining that the user is attempting to cause the device to reveal the redemption indicia 110, such as by receiving a message from the device indicating that the user has at least attempted to cause the device to reveal the redemption indicia 110, the message having been automatically transmitted in response thereto; determining whether the offer associated with the redemption indicia 110 is valid; and enabling the device to reveal the redemption indicia 110 if the offer associated with the redemption indicia is valid and otherwise preventing the device from revealing the redemption indicia 110.

The operation of the system 100 may further include receiving data indicative of the redemption of the offer from the merchant; and reconciling the received data with the accounted for redemption by the user to, for example, detect fraudulent redemption and/or determine marketing effectiveness of the offer, based on the reconciling.

Referring to FIG. 3, an illustrative embodiment of a general computer system 400 is shown. The computer system 400 can include a set of instructions that can be executed to cause the computer system 400 to perform any one or more of the methods or computer based functions disclosed herein. The computer system 400 may operate as a standalone device or may be connected, e.g., using a network, to other computer systems or peripheral devices. Any of the components discussed above may be a computer system 400 or a component in the computer system 400.

In a networked deployment, the computer system 400 may operate in the capacity of a server or as a client user computer in a client-server user network environment, or as a peer computer system in a peer-to-peer (or distributed) network environment. The computer system 400 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 400 can be implemented using electronic devices that provide voice, video or data communication. Further, while a single computer system 400 is illustrated, the term “system” shall also be taken to include any collection of systems or sub-systems that individually or jointly execute a set, or multiple sets, of instructions to perform one or more computer functions.

As illustrated in FIG. 3, the computer system 400 may include a processor 402, e.g., a central processing unit (CPU), a graphics processing unit (GPU), or both. The processor 402 may be a component in a variety of systems. For example, the processor 402 may be part of a standard personal computer or a workstation. The processor 402 may be one or more general processors, digital signal processors, application specific integrated circuits, field programmable gate arrays, servers, networks, digital circuits, analog circuits, combinations thereof, or other now known or later developed devices for analyzing and processing data. The processor 402 may implement a software program, such as code generated manually (i.e., programmed).

The computer system 400 may include a memory 404 that can communicate via a bus 408. The memory 404 may be a main memory, a static memory, or a dynamic memory. The memory 404 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one embodiment, the memory 404 includes a cache or random access memory for the processor 402. In alternative embodiments, the memory 404 is separate from the processor 402, such as a cache memory of a processor, the system memory, or other memory. The memory 404 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 404 is operable to store instructions executable by the processor 402. The functions, acts or tasks illustrated in the figures or described herein may be performed by the programmed processor 402 executing the instructions stored in the memory 404. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

As shown, the computer system 400 may further include a display unit 414, such as a liquid crystal display (LCD), an organic light emitting diode (OLED), a flat panel display, a solid state display, a cathode ray tube (CRT), a projector, a printer or other now known or later developed display device for outputting determined information. The display 414 may act as an interface for the user to see the functioning of the processor 402, or specifically as an interface with the software stored in the memory 404 or in the drive unit 406.

Additionally, the computer system 400 may include an input device 416 configured to allow a user to interact with any of the components of system 400. The input device 416 may be a number pad, a keyboard, or a cursor control device, such as a mouse, or a joystick, touch screen display, remote control or any other device operative to interact with the system 400.

In a particular embodiment, as depicted in FIG. 3, the computer system 400 may also include a disk or optical drive unit 406. The disk drive unit 406 may include a computer-readable medium 410 in which one or more sets of instructions 412, e.g. software, can be embedded. Further, the instructions 412 may embody one or more of the methods or logic as described herein. In a particular embodiment, the instructions 412 may reside completely, or at least partially, within the memory 404 and/or within the processor 402 during execution by the computer system 400. The memory 404 and the processor 402 also may include computer-readable media as discussed above.

The present disclosure contemplates a computer-readable medium that includes instructions 412 or receives and executes instructions 412 responsive to a propagated signal, so that a device connected to a network 420 can communicate voice, video, audio, images or any other data over the network 420. Further, the instructions 412 may be transmitted or received over the network 420 via a communication port 918. The communication port 418 may be a part of the processor 402 or may be a separate component. The communication port 418 may be created in software or may be a physical connection in hardware. The communication port 418 is configured to connect with a network 420, external media, the display 414, or any other components in system 400, or combinations thereof. The connection with the network 420 may be a physical connection, such as a wired Ethernet connection or may be established wirelessly as discussed below. Likewise, the additional connections with other components of the system 900 may be physical connections or may be established wirelessly.

The network 420 may include wired networks, wireless networks, or combinations thereof, and may be representative of the network 122, 124, 126, 128 in FIG. 1. The wireless network may be a cellular telephone network, an 802.11, 802.16, 802.20, or WiMax network. Further, the network 420 may be a public network, such as the Internet, a private network, such as an intranet, or combinations thereof, and may utilize a variety of networking protocols now available or later developed including, but not limited to TCP/IP based networking protocols.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP, HTTPS) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is therefore intended that the foregoing detailed description be regarded as illustrative rather than limiting, and that it be understood that it is the following claims, including all equivalents, that are intended to define the spirit and scope of this invention.

We claim:

1. A computer implemented method for managing an offer for a financial incentive, the method comprising:
transmitting to a device associated with a user interested in receiving offers for financial incentives, by the computer, data representative of the offer for the financial incentive, wherein the data comprises at least a redemption indicia operative to be presented to a merchant to obtain the financial incentive, and causing the device to conceal the redemption indicia until the user causes the device to reveal the redemption indicia;
determining, by the computer, that the user has caused the device to reveal the redemption indicia; and
accounting, by the computer, for the redemption of the offer by the user based thereon.

2. The computer implemented method of claim 1 wherein the device comprises a mobile device.

3. The computer implemented method of claim 1 wherein the financial incentive comprises a price discount for a product or service offered by the merchant.

4. The computer implemented method of claim 1 wherein the redemption indicia is unique to the user.

5. The computer implemented method of claim 1 wherein the redemption indicia comprises an alphanumeric code, a machine readable code, an image, an audible message, a signal operative to be transmitted via a radio frequency, or combination thereof.

6. The computer implemented method of claim 1 further comprising registering, by the computer, the device associated with the user, the computer storing an association between the user and the offer for the financial incentive represented by the transmitted data.

7. The computer implemented method of claim 6 wherein the registering further comprises receiving user data representative of at least one of the user's interests, preferences, demographics, biographical information, or combinations thereof.

8. The computer implemented method of claim 7 further comprising:
prior to the transmitting, determining the offer from a plurality of offers available to be provided to the user based on the received user data.

9. The computer implemented method of claim 1 wherein the transmitting further comprises transmitting in response to a request received from the device.

10. The computer implemented method of claim 1 wherein the data representative of the offer for the financial incentive further comprises a description of the offer operative to be displayed by the device.

11. The computer implemented method of claim 1 wherein the data representative of the offer for the financial incentive further comprises a condition to be satisfied to enable the user to cause the device to reveal the redemption indicia.

12. The computer implemented method of claim 11 wherein the condition comprises a substantial convergence between specified geographic coordinates and coordinates provided by a GPS device contained within the device.

13. The computer implemented method of claim 11 wherein the condition comprises performance of a confirmatory action by the merchant.

14. The computer implemented method of claim 1, the method further comprising:
prior to the determining that the user has caused the device to reveal the redemption indicia, determining that the user is attempting to cause the device to reveal the redemption indicia;
determining whether the offer associated with the redemption indicia is valid; and
enabling the device to reveal the redemption indicia if the offer associated with the redemption indicia is valid and otherwise preventing the device from revealing the redemption indicia.

15. The computer implemented method of claim 1 wherein the determining further comprises receiving a message from the device indicating that the user has at least attempted to cause the device to reveal the redemption indicia, the message having been automatically transmitted in response thereto.

16. The computer implemented method of claim 1 further comprising enabling the device to reveal the redemption indicia in response to a specific user interaction with the device.

17. The computer implemented method of claim 16 wherein the specific user interaction comprises a simulated scratching motion on an interactive display of the device.

18. The computer implemented method of claim 1 wherein the accounting further comprises invalidating the offer for subsequent redemption.

19. The computer implemented method of claim 1 wherein the accounting further comprises adjusting a count of the number of redemptions of the offer.

20. The computer implemented method of claim 1 further comprising:
receiving data indicative of the redemption of the offer from the merchant; and
reconciling the received data with the accounted for redemption by the user.

21. The computer implemented method of claim 20 further comprising:
detecting fraudulent redemption based on the reconciling.

22. The computer implemented method of claim 20 further comprising:
determining marketing effectiveness of the offer based on the reconciling.

23. The computer implemented method of claim 1 wherein the transmitting further comprises transmitting the data via an application executing on the device.

24. The computer implemented method of claim 23 wherein the application comprises a web browser program.

25. A system for managing an offer for a financial incentive, the system comprising:
an offer server operative to transmit to a device associated with a user interested in receiving offers for financial incentives, data representative of the offer for the financial incentive, wherein the data comprises at least a redemption indicia operative to be presented to a merchant to obtain the financial incentive, and cause the device to conceal the redemption indicia until the user causes the device to reveal the redemption indicia; and
wherein the offer server is further operative to determine that the user has caused the device to reveal the redemption indicia and, based thereon, account for the redemption of the offer by the user.

26. The system of claim 25 wherein the device comprises a mobile device.

27. The system of claim 25 wherein the financial incentive comprises a price discount for a product or service offered by the merchant.

28. The system of claim 25 wherein the redemption indicia is unique to the user.

29. The system of claim 25 wherein the redemption indicia comprises an alphanumeric code, a machine readable code, an image, an audible message, a signal operative to be transmitted via a radio frequency, or combination thereof.

30. The system of claim 25 wherein the offer server is further operative to register the device associated with the user, the offer server being operative to store, in a database, an association between the user and the offer for the financial incentive represented by the transmitted data.

31. The system of claim 30 wherein the offer server is further operative to receive user data representative of at least one of the user's interests, preferences, demographics, biographical information, or combinations thereof.

32. The system of claim 31 wherein the offer server is further operative, prior to the transmission of the data representative of the offer, determine the offer from a plurality of offers available to be provided to the user based on the received user data.

33. The system of claim 25 wherein the offer server is further operative to transmit the data representative of the offer in response to a request received from the device.

34. The system of claim 25 wherein the data representative of the offer for the financial incentive further comprises a description of the offer operative to be displayed by the device.

35. The system of claim 25 wherein the data representative of the offer for the financial incentive further comprises a condition to be satisfied to enable the user to cause the device to reveal the redemption indicia.

36. The system of claim 35 wherein the condition comprises a substantial convergence between specified geographic coordinates and coordinates provided by a GPS device contained within the device.

37. The system of claim 35 wherein the condition comprises performance of a confirmatory action by the merchant.

38. The system of claim 25, wherein the offer server is further operative to prior to the determination that the user has caused the device to reveal the redemption indicia, determining that the user is attempting to cause the device to reveal the redemption indicia, determine whether the offer associated with the redemption indicia is valid and enable the device to reveal the redemption indicia if the offer associated with the redemption indicia is valid and otherwise prevent the device from revealing the redemption indicia.

39. The system of claim 25 wherein the offer server is further operative to determine that the user has caused the device to reveal the redemption indicia based on receipt of a message from the device indicating that the user has at least attempted to cause the device to reveal the redemption indicia, the message having been automatically transmitted in response thereto.

40. The system of claim 25 wherein the offer server is further operative to enable the device to reveal the redemption indicia in response to a specific user interaction with the device.

41. The system of claim 40 wherein the specific user interaction comprises a simulated scratching motion on an interactive display of the device.

42. The system of claim 25 wherein the offer server is further operative to invalidate the offer for subsequent redemption based on the determination that the user has caused the device to reveal the redemption indicia.

43. The system of claim 25 wherein the offer server is further operative to adjust a count of the number of redemptions of the offer based on the determination that the user has caused the device to reveal the redemption indicia.

44. The system of claim 25 wherein the offer server is further operative to receive data indicative of the redemption of the offer from the merchant and reconcile the received data with the accounted for redemption by the user.

45. The system of claim 44 wherein the offer server is further operative to detect fraudulent redemption based on the reconciliation.

46. The system of claim 44 wherein the offer server is further operative to determine marketing effectiveness of the offer based on the reconciliation.

47. The system of claim 25 wherein the offer server is further operative to transmit the data via an application executing on the device.

48. The system of claim 47 wherein the application comprises a web browser program.

49. A system for managing an offer for a financial incentive, the system comprising a processor and a memory coupled therewith, the system further comprising:
first logic stored in the memory and executable by the processor to cause the processor to transmit to a device associated with a user interested in receiving offers for financial incentives, data representative of the offer for the financial incentive, wherein the data comprises at least a redemption indicia operative to be presented to a merchant to obtain the financial incentive, and cause the device to conceal the redemption indicia until the user causes the device to reveal the redemption indicia; and
wherein the first logic is further executable by the processor to cause the processor to determine that the user has caused the device to reveal the redemption indicia and, based thereon, account for the redemption of the offer by the user.

50. A system for managing an offer for a financial incentive, the system comprising:
means for transmitting to a device associated with a user interested in receiving offers for financial incentives data representative of the offer for the financial incentive, wherein the data comprises at least a redemption indicia operative to be presented to a merchant to obtain the financial incentive, and means for causing the device to conceal the redemption indicia until the user causes the device to reveal the redemption indicia;
means for determining that the user has caused the device to reveal the redemption indicia; and
means for accounting for the redemption of the offer by the user based thereon.
